(19) United States
(12) Patent Application Publication
(10) Pub. No.: US 2018/0088592 A1
(43) Pub. Date: Mar. 29, 2018

(54) AUTONOMOUS ROBOTIC AIRSHIP INSPECTION SYSTEM FOR LARGE-SCALE TANK INTERIORS

(71) Applicants: CALIFORNIA INSTITUTE OF TECHNOLOGY, Pasadena, CA (US); CHEVRON U.S.A. INC., San Ramon, CA (US)

(72) Inventors: Matthew GILDNER, PASADENA, CA (US); Donald F. RUFFATTO, PASADENA, CA (US); Sophia MITCHELL, PASADENA, CA (US); Oktay ARSLAN, PASADENA, CA (US); Joshua Vander HOOK, PASADENA, CA (US); Jolly JAMES, KATY, TX (US); Robert Kwan Meng SEAH, CYPRESS, TX (US); Nick MARKOV, VARNA (BG)

(21) Appl. No.: 15/714,693

(22) Filed: Sep. 25, 2017

Related U.S. Application Data
(60) Provisional application No. 62/415,665, filed on Nov. 1, 2016.
(60) Provisional application No. 62/399,790, filed on Sep. 26, 2016.

(51) Int. Cl. G05D 1/04; G05D 1/02; B64B 1/06; B64B 1/70

(52) U.S. Cl. CPC G05D 1/042; G05D 1/0202; G05D 1/0022; B64B 1/70; B64B 1/06

(57) ABSTRACT

Designing intrinsically safe robotic inspection systems used for unmanned navigation and inspection of large tanks with hazardous and explosive atmosphere is challenging. The disclosed methods and devices provide solutions to overcome such challenge. Intrinsically safe devices and methods using a combination of a lighter-than-air blimp with various intrinsically safe subsystems attached to the blimp are presented.

### CROSS-REFERENCE TO RELATED APPLICATIONS

The present application claims priority to provisional patent applications U.S. 62/399,790 filed on Sep. 26, 2016 and entitled “Autonomous Robotic Airship Inspection System for Large-Scale Tank Interiors” and U.S. 62/415,665, filed on Nov. 1, 2016 and entitled “Planning and Navigation System for Robotic Aerial Vehicles Inspecting Large-Scale Tank Interiors” both of which are incorporated herein by reference in their entirety.

### GOVERNMENT INTEREST

The invention described herein was made in the performance of work under a NASA contract NNN12AA01C, and is subject to the provisions of Public Law 96-517 (35 USC 202) in which the Contractor has elected to retain title.

### BACKGROUND

### (1) Technical Field

The present disclosure is related to airship inspection systems, and more particularly to methods and apparatus for autonomous airship inspection systems for large-scale tank interiors.

### (2) Background

Offshore platforms and Floating Production and Storage and Offloading vessels (FPSOs) require visual inspection of cargo, ballast, and void tanks to assess the condition of the tank coatings and the tanks' structural integrity. Many industries require routine, manned inspection of such large-scale (10 m+) tanks. These inspections can expose inspectors to dangerous conditions, such as confined entry, elevated heights, and hazardous/explosive atmospheres. Furthermore, the quality of manned inspections is often hampered by the inability to provide comprehensive and quantitative inspection data.

An autonomous robotic visual inspection system has many advantages over manned inspections. These advantages included reduction to exposure and increase fidelity and localization of inspection data. Traditional robotic inspection platforms (multi-rotor aerial vehicles, ground vehicles, etc.) are not suitable for large-scale tank environments due to the navigation complexity and accessibility of tank interiors and restrictions posed by environments with hazardous/explosive atmospheres. Satellite-based GPS is not available inside most tanks.

### (3) State of the Art of Robotic Visual Inspection Systems

Unmanned Aerial Vehicles (UAVs) are frequently being used to perform visual inspections due to their ability to access locations which are inaccessible, unsafe or costly for manned inspections. This section provides a brief overview of commercially available UAV inspection systems. Limitations of these systems with respect to tank inspection requirements are also discussed.

### (3.1) Small, Fixed Wing UAVs

Small, fixed-wing inspection UAVs shared many similarities with manned fixed-wing craft, in that they are able to quickly survey large regions by flying overhead. These vehicles cost much less to operate compared to manned craft and are able to be deployed in environments which pose too high of a risk to manned fixed wings. Small, fixed-wing UAVs have evolved out of larger UAV systems employed by defense organizations for surveillance/combat and small radio-controlled air craft. The miniaturization of avionics electronics and the dramatic increase in battery density has led to the design of small (less than 3 m wingspan) and lightweight (less than 5 kg) vehicles which can be deployed by 1-2 operators. Most vehicles are equipped with GPS and IMU sensors allowing for autopilot control along fixed paths. More advanced functionality, such as obstacle avoidance and indoor navigation, are not found on commercially available small, fixed-wing UAVs. Maneuverability is also hampered by the need for constant forward motion to generated lift. Combined, the lack of advance navigation functionality and maneuverability make small, fixed-wing UAVs unsuitable for tank inspection.

### (3.2) Multirotor UAVs

Multirotor UAVs, are highly maneuverable aerial robots with at least four vertically oriented propeller-based thrusters. These vehicles' maneuverability and low cost have made them an effective robotic platform for inspection of close range assets. Multirotor UAVs have been developed in the past ranging in size from 10's of grams to several kilograms and can reach top speeds of over 160 km/hr. Most vehicles are equipped with GPS, IMU and range sensors to stabilize the vehicles and locate and avoid obstacles. Unlike fixed-wing UAVs, multirotor UAVs are able to navigate close to obstacles and in indoor environments due to their maneuverability and onboard sensing. Manual piloting via onboard camera with various autopilot functions such as obstacle avoidance and return to home is common among commercial multirotor UAVs.

More advance functionality such as waypoint following and visual navigation is be-coming more common among commercial off the shelf (COTS) systems, albeit with applications in mostly benign environments. Multirotor UAVs are limited by their flight duration, payload capacity and ability to navigate more complex environments. Flight durations range from a few minutes to almost an hour. Larger systems are able to support payloads of several kilograms, of-ten being taken up by cameras, gyro-stabilized gimbals and other inspection sensors such as laser scanners.

Visual navigation is the preferred approach for navigating multirotor UAVs in complex indoor environments without the aid of satellite-based GPS. These visual navigation systems are typically very sensitive to lighting and textures within the environment, limiting their reliability. However, this subject is a very active area of research and the sophistication and reliability of the visual navigations systems found on COTS multirotor UAVs is advancing rapidity. Such UAVs are equipped with optical flow sensors to measure the vehicle's speed in all directions and 3D cameras to detect and avoid obstacles. Ultrasonic range sensors are also provided in the case of poor camera performance in certain environments. Multirotor UAVs of suitable size for industrial inspection require more than 100 W to power strong thrusters and large avionic systems. This characteristic of these vehicles makes them unsuitable for intrinsically safe applications. Furthermore, the level of autonomous planning, navigation and control infrastructure currently available for COTS multirotor UAVs cannot provide sufficient levels of operational risk mitigation and inspection fidelity necessary for tank inspection. Most systems still required pilots to keep line of sight with the vehicle and survey paths cannot be autonomously updated during mission based on a new obstacle. Vehicles that are robust to collisions offer an alternative to sophisticated indoor navigation technology. The design of such vehicles allows them to navigate through indoor environments beyond a pilot's line of sight without the use of visual navigation technology. However, reliance on collision robustness rather than navigation technology comes at the cost of inspection fidelity. Images and videos collected by the vehicle can only be crudely localized based on manual analysis, making it difficult to assess specific features of interest or insure complete coverage of geometrically complex assets.

(3.3) Lighter than Air UAVs

Lighter than air UAVs (LTA UAVs) are robotic vehicles which rely on the vehicle's buoyancy to stay aloft rather than lift generated by forward motion or thrusters. They are similar in designed to manned blimps and dirigibles, but are typically smaller with envelop volumes less than 15 m̂3. Like manned LTA systems, a lifting gas, typically helium, is stored inside a pressurized envelope. The volume of the envelope is selected based on the vehicle's payload requirements to achieve near neutral buoyancy. In the case of variable payloads and ambient density changes, LTA UAVs can incorporate buoyancy compensation through the use of ballasting systems. Maneuvering is achieved through the use of propeller-based thrusters and in most cases control surfaces.

LTA UAVs offer several advantages over other UAVs systems. They offer similar maneuverability to multirotor UAVs while operating at low speeds and consuming much less power. They also suffer from less failure degradation, making them robust to environments with unknown parameters. Given an appropriately designed lifting gas envelope, LTA UAVs can be made robust to low impact collisions unlike most multirotor and fixed-wing UAVs. Avionics and sensors integrated into other UAV systems can also be found on LTA UAVs, enabling stabilized flight and navigation in outdoor and indoor environments.

Size presents one of the primary limitations on the use of LTA UAVs for indoor applications. An LTA UAV payload capacity is proportional to it envelope volume. This is essentially a restriction that makes LTA UAVs unsuitable for constricted environments. Large-scale tank inspection applications can still be well served by LTA UAVs in this regard as long as accommodations are made for tank access and vehicle deployment.

Environmental loading also places limitations of the use of LTA UAVs. This loading comes in the form of drag and buoyancy-induced lift. The large size of LTA UAVs results in significant drag forces on vehicles in moderate wind conditions. While larger manned LTA systems can compensate for drag loads with powerful propulsion systems, LTA UAVs are equipped with propulsion systems that provide 1-3 orders of magnitude less thrust than manned systems. In applications where path following and station keeping are required, this constraint limits LTA UAVs to environments with near zero ambient air speeds. Buoyancy-induced lift can constrain LTA UAVs if the ambient air density or vehicle payload changes drastically over the course of a mission. Ballasting systems that are used to compensate for such changes rely on the use of consumables. In the case of a fixed ballast consumable, increased ambient density changes, e.g. large temperate differentials, will result in reduced vehicle mission life.

In view of above, UAVs requiring low power for maneuvering through a tank are needed. It is highly desired that such UAVs lend themselves to intrinsically safe proofing measures required for deployments in hazardous/explosive atmospheres. Moreover, Autonomous planning, navigation and control infrastructure to reduce system operation risk are also required.

### SUMMARY

Design of UAVs that are unmanned, autonomous and well suited for inspection of large-scale tanks with hazardous/explosive atmospheres is challenging. Methods and devices taught in the present disclosure provide solutions to this problem and overcome shortcomings of existing systems as described above.

According to a first aspect of the present disclosure, an intrinsically safe (IS) robotic inspection system for unmanned inspection of environments with hazardous and explosive atmosphere is provided, comprising: 1) an IS blimp comprising: an IS envelope subsystem; an IS avionics and buoyancy subsystem attached to the IS envelope subsystem; an IS mobility system attached to the IS envelope subsystem; an IS inspection subsystem attached to the IS envelope subsystem, an IS docking subsystem attached to the IS envelope subsystem; and a ground station subsystem; and 2) a mission planning and control system; wherein: (a) the IS blimp is a lighter-than-air blimp; (b) the IS envelope provides structural support for the IS avionics and buoyancy, the IS mobility, the IS inspection and the IS docking subsystems; (c) in an operative condition wherein the IS blimp performs navigation and inspection functions within the environments: (c1) the IS avionics and buoyancy subsystem adjusts an IS blimp buoyancy to compensate for ambient density and temperature gradients; (c2) the IS avionics and buoyancy subsystem controls the navigation and the inspection functions of the IS blimp by providing control commands to the IS mobility and the IS inspection subsystems; (c3) the IS mobility subsystem provides propulsion to maneuver the IS blimp; and (c4) the IS inspection subsystem acquires images of the environments as part of the navigation and inspection functions; and (d) a combination of the ground station subsystem and the IS docking subsystem provide mechanism for unmanned release and docking of the IS blimp within the environments. (e) the mission planning and control system provides offline software infrastructure for supporting the navigation and the inspection functions.

According to a second aspect of the present disclosure, An automated and unmanned method of navigating and inspecting a tank with hazardous and explosive atmosphere is disclosed, providing: providing an intrinsically safe (IS) and lighter-than-air blimp, attaching IS cameras, IS LED light, IS sensors, IS motors, IS propellers, IS computers and IS communication and control boards to the blimp to provide a robotic inspection system, the robotic inspection system being intrinsically safe; docking the robotic inspection system on a docking station within the tank; releasing the robotic inspection system to start a mission; providing control commands to the IS cameras, the IS LED lights, the IS sensors, the IS propellers using a combination of the IS computers and the IS communication and control boards; adjusting the blimp's buoyancy during the mission; providing a vectored propulsion to maneuver the blimp during the mission and using a combination of the IS sensors, the IS motors and the IS propellers; acquiring images of the tank environment using a combination of the IS cameras and the IS LED lights; and returning to the docking station at an end of the mission.

### DESCRIPTION OF THE DRAWINGS

FIG. 1A shows a Robotic Inspection of Tanks (RIOT) system according to an embodiment of the disclosure.

FIG. 1B shows an envelope subsystem cross section.

FIG. 1C shows an Avionics and Buoyancy subsystem.

FIG. 1D shows a Mobility subsystem.

FIG. 1E shows an Inspection subsystem.

FIG. 1F shows a Docking subsystem.

FIG. 1G shows a diagram illustrating deployment of a blimp in a tank

### DETAILED DESCRIPTION

Intrinsic safety is a protection technique for safe operation of electrical equipment in hazardous areas by limiting the energy, electrical and thermal, available for ignition. In other words, an intrinsically safe (IS) system or equipment that operates in an atmosphere where fuel and oxygen are present is designed such that the electrical energy or thermal energy of a particular instrument can never be great enough to cause ignition. Several different agencies develop standards for intrinsic safety, and evaluate products for compliance with standards. Throughout this paper, an IS system or an IS component is defined as a system or a component that is designed in accordance with an IS standard wherein the IS standard is one of International Electrical Commission (IEC) IEC 60079-11, Factory Mutual (FM) 3610, and Underwriters Laboratories (UL) UL913.

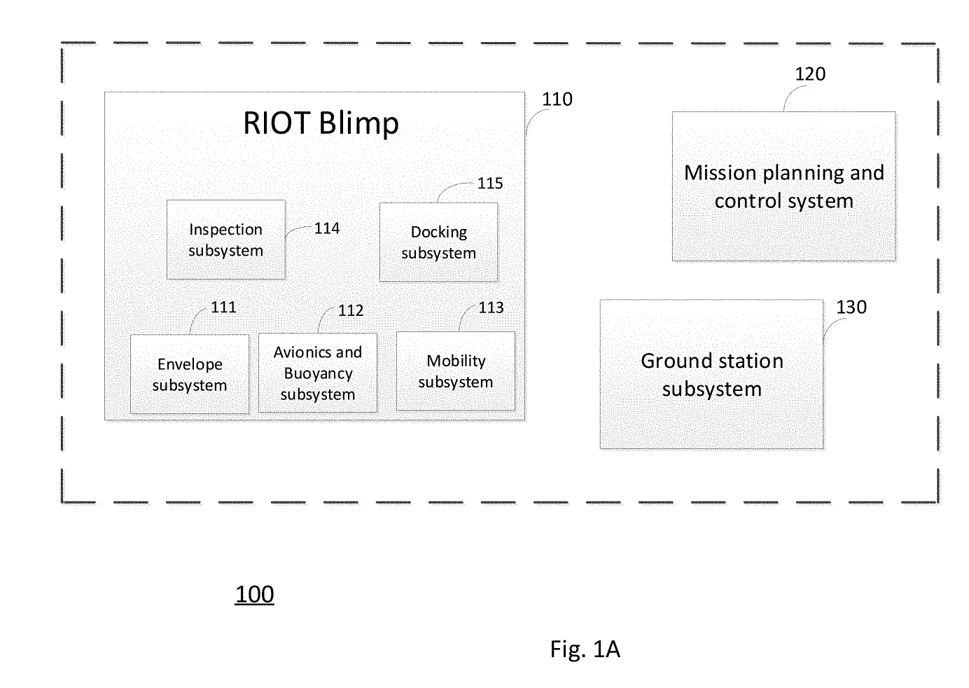

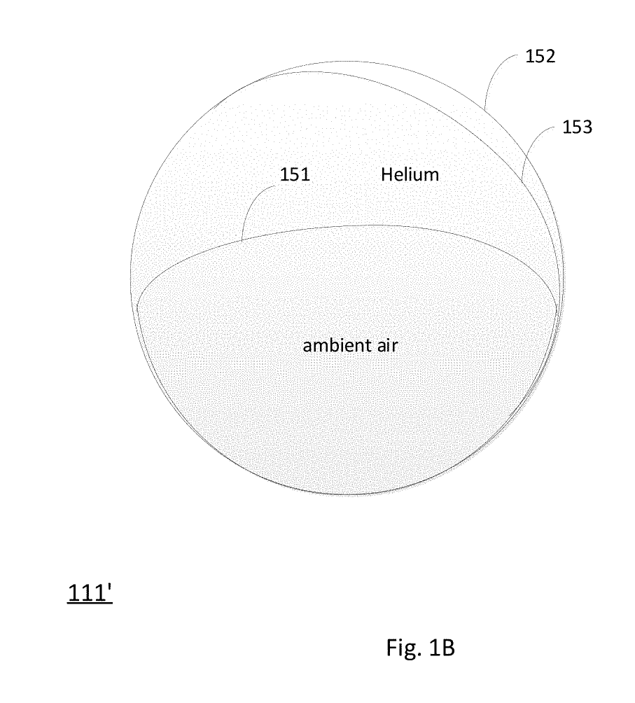

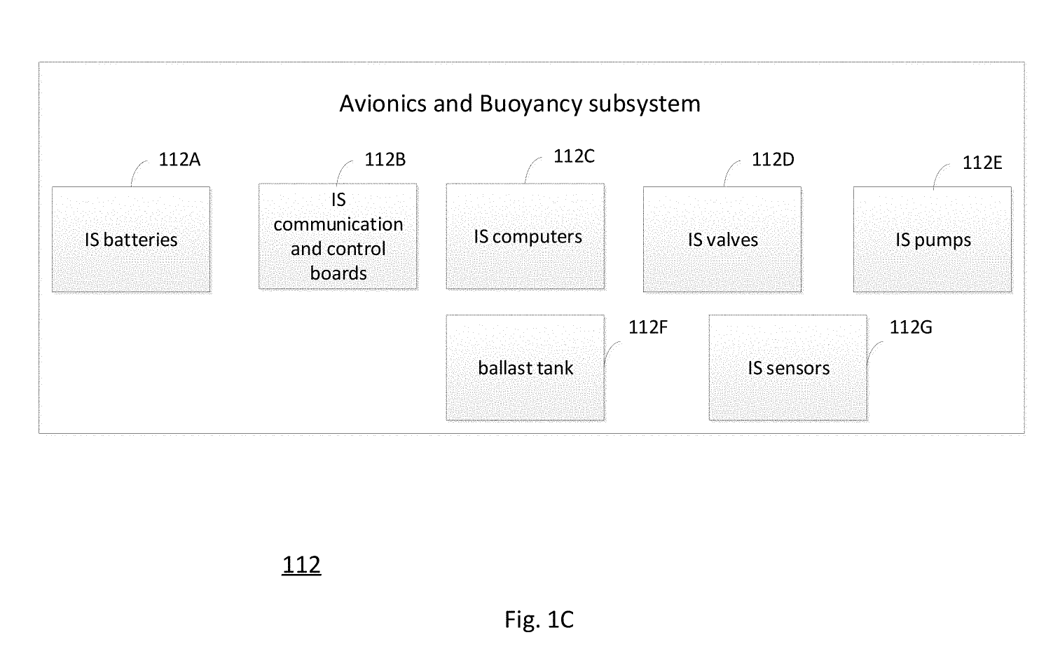

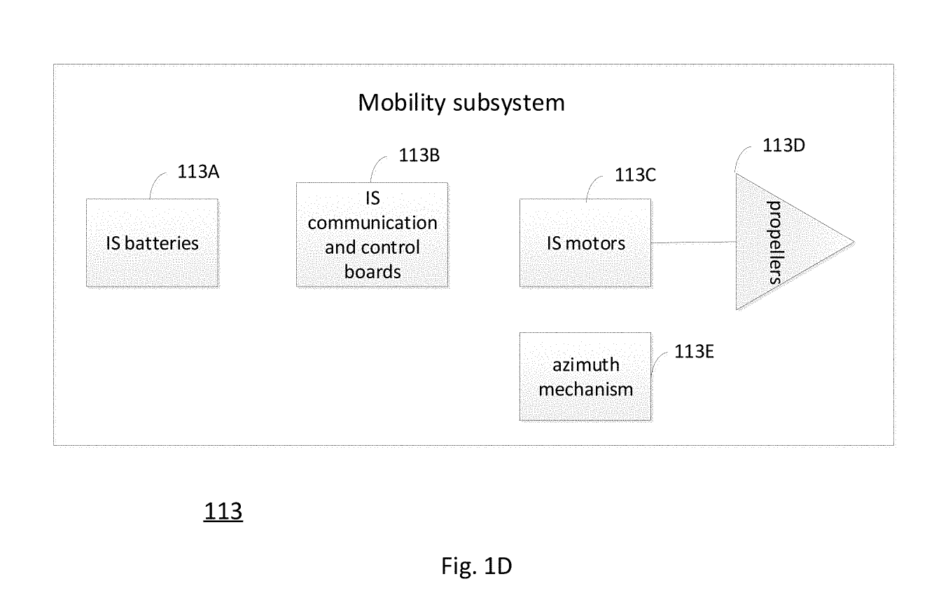

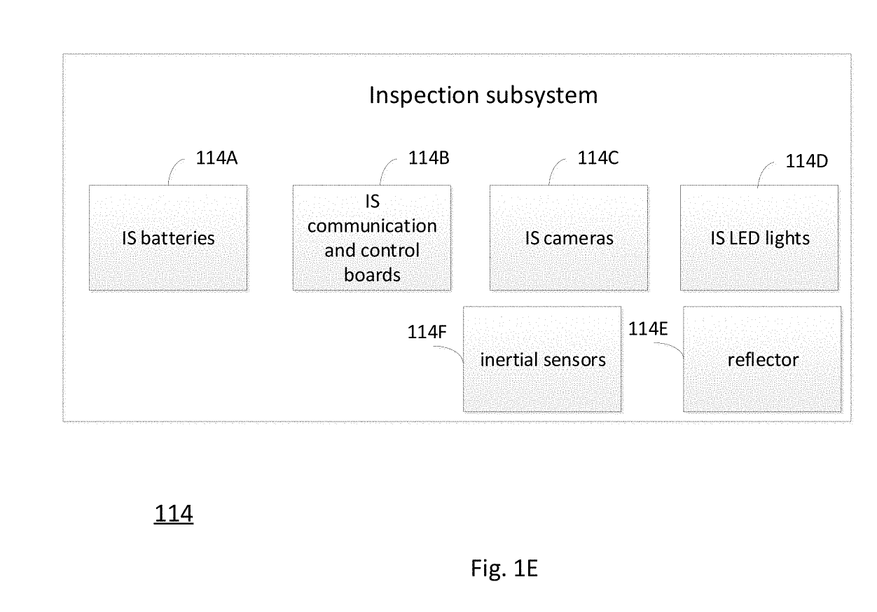

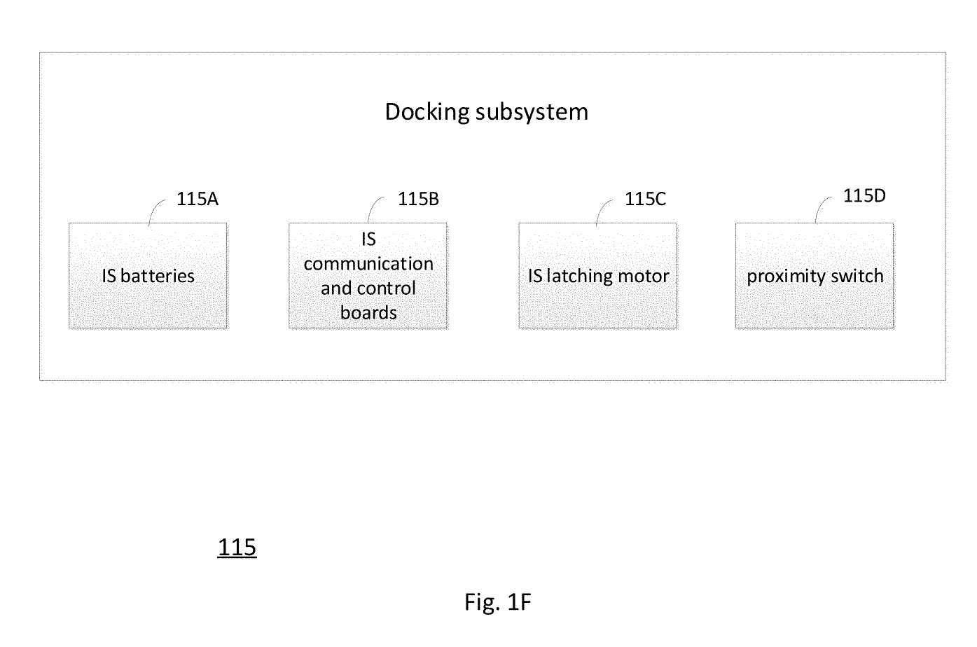

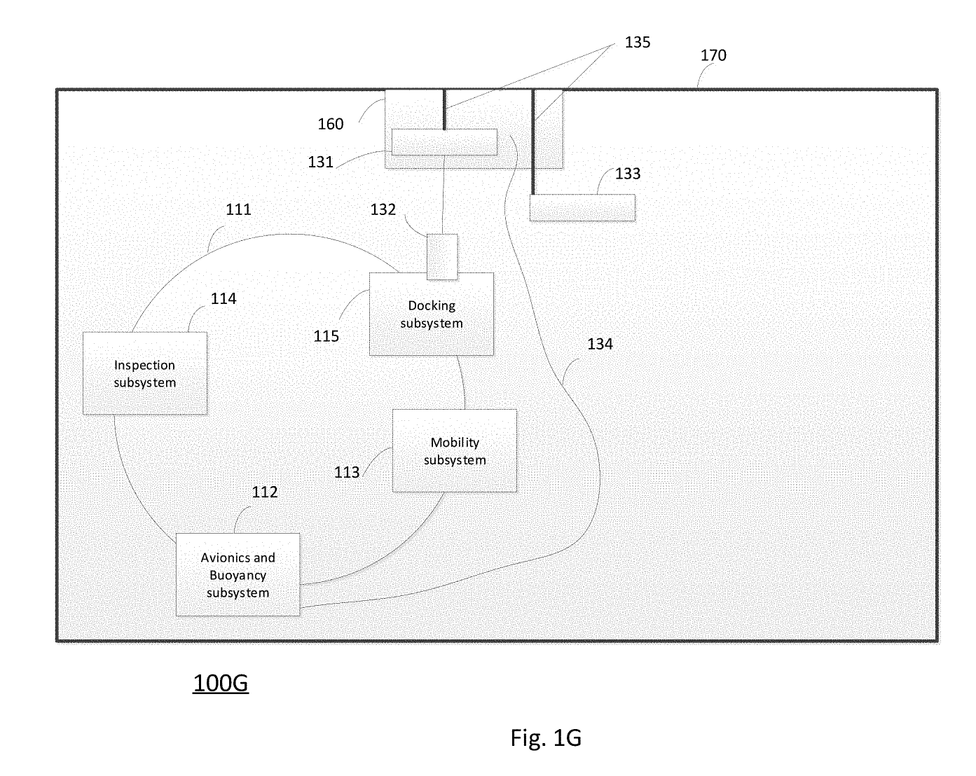

FIG. 1 shows a Robotic Inspection of Tanks (RIOT) system (100) according to an embodiment of the disclosure. The RIOT system (100) comprises a RIOT Blimp (110), RIOT Ground Station subsystem (130) and a Mission Planning and Control System (120). In accordance with an embodiment of the disclosure, the RIOT Blimp (110) is an intrinsically safe aerial, robotic system based on a lighter-than-air design. Moreover, the RIOT Blimp (110) comprises an Envelop subsystem (111), an Avionics and Buoyancy subsystem (112), a Mobility subsystem (113), an Inspection subsystem (114) and a Docking subsystem (115). According to teachings of the disclosure, modular approach may be undertaken to various above-mentioned subsystems so that individual subsystems could be further developed for intrinsic safety on an individual basis. In other words, and according to some embodiments of the disclosure, each of the subsystems (111-115) is intrinsically safe.

FIG. 1B shows a cross section 111′ of the envelope subsystem (111) of FIG. 1A. In accordance with an embodiment of the disclosure, the subsystems (112-115) are attached to the Envelope subsystem (111). In other words, mechanical structural support for the subsystems (112-115) is provided by the Envelope subsystem (111). Referring to FIG. 1B, the Envelope subsystem (111) comprises inner helium envelope (153), a ballonet (151), and an outer layer (152), the outer layer (152) providing strength to resist the Envelope subsystem's (111) over pressure and provide protection against the environment. According to an embodiment of the disclosure, the ballonet (151) is made up of one impermeable layer and is designed to be under-filled, so no overpressure needs to be withstood by the outer layer (152). As shown in FIG. 1B, the Envelope subsystem (111) comprises helium served as lifting gas and the ballonet (151) is filled with ambient air in accordance with embodiments of the disclosure. According to further embodiments of the disclosure, the outer layer (152) may maintain a slight overpressure between 450-7000 Pa.

FIG. 1C shows the Avionics and Buoyancy subsystem (112) comprising Avionics and Buoyancy IS batteries (112A), Avionics and Buoyancy IS communication and control boards (112B), IS computers (112C), IS valves (112D), IS pumps (112E), a ballast tank (112F) and IS sensors (112G). One of the functions of the Avionics and Buoyancy subsystem (112) is to adjust the RIOT Blimp's (110) buoyancy to compensate for varying ambient atmosphere densities. Referring also to FIGS. 1A-1B and as described previously, the primary purpose of using the ballonet (151) is to adjust the buoyancy in the presence of such ambient density gradients. The ballonet (151) envelope is attached to the Avionics and Buoyancy subsystem (112) allowing it to be filled and emptied with ambient air via the IS pumps (112E). If the ambient density increases due to cold temperatures or heavy gas mixtures, the ballonet (151) is filled to increase the RIOT Blimp's (110) mass. As the ballonet (151) is filled, the helium overpressure increases. If it exceeds its maximum design pressure, the IS valves (112) release helium into the ambient atmosphere. In this way, helium acts as consumable resource over the course of a mission. Due to possibly high gradients of air density, the Avionics and Buoyancy subsystem (112) may implement an additional mechanism for buoyancy control using the ballast tank (112F). For example, if the ambient density decreases and the vehicles needs to increase its buoyancy, water ballast is released from the ballast tank (112) using a combination of the IS valves (112D) and IS pumps (112E). According to an embodiment of the disclosure, the IS computers (112C) may incorporate encapsulation in accordance with an IS standard chosen from one of a) International Electrical Commission (IEC) IEC 60079-11, b) Factory Mutual (FM) 3610, or c) Underwriters Laboratories (UL) UL913.

Referring back to FIG. 1C, the Avionics and Buoyancy IS communication and control boards (112B) control functionalities of the IS valves (112D) and IS pumps (112E). The Avionics and Buoyancy IS batteries (112A) provide required power to other elements (112B-112G) of the Avionics and Buoyancy subsystem (112). According to some embodiments of the disclosure, the Avionics and Buoyancy IS batteries (112A) comprise Lithium batteries. Measurements from the IS sensors (112G) are used to detect and avoid obstacles thereby allowing the RIOT Blimp (110) of FIG. 1A to maneuver throughout the mission. By way of example, such measurements are used for altitude, angular rate, velocity or position calculation purposes. According to embodiments of the disclosure, the IS sensors (114G) comprise inertial measurement units (IMU), the IMUs comprising accelerometers and gyros. The Avionics and Buoyancy subsystem (112) provides additional functionalities that will be explained more in detail later in this paper.

FIG. 1D shows the Mobility system (113) in accordance with an embodiment of the disclosure. The Mobility system (113) comprises Mobility IS batteries (113A), Mobility IS communication and control boards (113B), IS motors (113C), propellers (113D) and an azimuth mechanism (113E). A function of the Mobility system (113) is to provide propulsion to stabilize and maneuver the RIOT Blimp (110) through a tank environment. This is accomplished by the propellers (113D) being driven by the IS motors (113C). According to an embodiment of the disclosure, the azimuth mechanism (113E) is also driven by a motor of the IS motors (113C) thereby allowing the RIOT Blimp's (110) thrusts to be vectored. The Mobility IS communication and control boards (113B) provide control commands to the IS motors (113C) and various elements of the Mobility system (113) are powered by the Mobility IS batteries (113A). According to embodiments of the disclosure, the Mobility system IS batteries (112A) comprise Lithium batteries. In accordance with another embodiment of the disclosure, the IS motors (113C) comprises a plurality of motors.

FIG. 1E shows the Inspection subsystem (114) according to an embodiment of the disclosure. The Inspection subsystem (114) comprises Inspection IS batteries (114A), Inspection communication and control boards (114B), IS cameras (114C), IS light emitting diode (LED) lights (14D), a reflector (114E) and inertial sensors (114F). A function of the Inspection subsystem (114) is to acquire images of a tank environment using the IS cameras (114C) for navigation and inspection purposes. The LED lights (114D) are mounted adjacent to the reflector (114E) to better disperse light in the environment. According to some embodiments of the disclosure, the IS cameras (114C) comprise a lens and a high resolution miniature camera which is a visible light camera. The visible light camera and the lens are selected to provide adequate viewshed and resolution of sub-centimeter scale features. In accordance with the teachings of the disclosure, some embodiments may be envisaged wherein infrared cameras and time-of-flight cameras, instead of visible light cameras, may be used to aid in non-ambient light environment visual navigation. Further embodiments according to the teachings of disclosure may be made, wherein the IS cameras (114C) comprise non-contact 3D reconstruction sensor such as a Lidar. The person skilled in the art will appreciate that the RIOT Blimp (110) of FIG. 1A will rely on visual navigation due to lack of Global Positioning System (GPS) inside the tank environment. Referring to FIGS. 1C and 1E, a combination of the IS sensors (112G) and the IS cameras (114C) provide a GPS independent visual navigation solution based on the teachings of the disclosure. Path following and obstacle avoidance are made possible without presence of satellite-based GPS. Moreover, and according to other embodiments of the disclosure, algorithms provided by an onboard software within the Avionics and Buoyancy subsystem (112), combined with high rate inertial measurements may be used to provide a six degree of freedom pose estimate of the RIOT blimp (110. According to an embodiment of the disclosure, cm-scale image localization accuracy and/or mm-scale feature size detectability may be obtained using a combination of the IS cameras (114C) and the inertial sensors (114F). In accordance with further embodiments of the disclosure, the Inspection subsystem (114) comprises onboard data storage to store inspection images for offline analysis.

FIG. 1F shows the Docking subsystem (115) providing mechanisms for release and docking of the RIOT Blimp (110) of FIG. 1A within a tank environment. The Docking subsystem (115) comprises docking IS batteries (115A), docking IS communication and control boards (115B), an IS latching motor (115C) and a proximity switch (115D). The IS latching motor (115C) and the proximity switch (115D) are essentially IS mechanical and electrical elements that are used to deploy the RIOT Blimp (110) of FIG. 1A. At the start of a deployment, the RIOT Blimp (110) is inserted into the tank on the Ground Station subsystem (130) of FIG. 1A, in an empty state and via a deployment boom or winch. The envelopes (151, 152) of FIG. 1B will then be filled by a hose running down the deployment boom or winch. Once filled, a release mechanism will allow the RIOT Blimp (110) to begin its mission. At the completion of the inspection mission, the RIOT Blimp (110) vehicle will maneuver back to the deployment boom and dock to the boom. Once docked, the envelopes (151, 152) of FIG. 1B will be pumped out and the RIOT blimp (110) will be removed from the tank. Various elements of the docking subsystem (115), e.g., 115B-115D are powered by the docking IS batteries (115A). According to an embodiment of the disclosure, the RIOT blimp (110) is able to return to the docking station autonomously under various missions scenarios (e.g. completion, low power, etc.). According to further teachings of the disclosure, both deployment and recovery of the RIOT Blimp (110) are performed without man entry to tanks.

FIG. 1G shows a diagram 100G illustrating deployment of the Riot blimp (110) of FIG. 1A in a large tank (170) comprising a tank hatch (160). The Ground station subsystem (130) of FIG. 1A, provides mechanisms for deploying, recovering, and communicating with the RIOT Blimp (110) of FIG. 1A. The Ground Station subsystem (130) of FIG. 1A comprises an IS docking mechanism (132), an IS hoist mechanism (131), helium gas lines (134), an IS communication antenna (133), and an IS feedthrough harnessing (135). According to an embodiment of the disclosure, the IS hoist mechanism (131) comprises a winch or boom. During deployment, the IS hoist mechanism (131) is used to lower the RIOT Blimp (110) of FIG. 1A into the large tank (170) in an empty state. The helium gas lines (134) are used to fill the RIOT Blimp (110) of FIG. 1A through the Avionics and Buoyancy subsystem (112) and once the RIOT blimp (110) of FIG. 1A is lowered. The IS docking mechanism (132) releases the RIOT blimp (110) of FIG. 1A after filling. The IS docking mechanism (132) interfaces with the docking subsystem (115) to enable release and recover of the RIOT Blimp (110) of FIG. 1A. The IS communication antenna (133) provides a communication link between RIOT Blimp (110) and communication and computing infrastructures exterior to the tank (170). The IS feedthrough harnessing (135) provides power and communication channels through the tank hatch (160) or an air lock to the Ground Station components.

Referring back to the Avionics and Buoyancy subsystem (112) of FIG. 1C, in accordance with further embodiments of the disclosure, the IS computers (112C) comprise two computing elements running onboard software. A first computing element provides low level control of the vehicle's various sensors and mechanisms. Referring to FIGS. 1D-1E, examples of low level control are changing thrust of propellers (113D) of the Mobility subsystem (113), updating a collision map and updating RIOT blimp's position in the map, turning IS LEDs (114D) of the inspection subsystem (114) on and off, sending commands to IS cameras (114C) to take pictures etc. A second computing element acts as a mission computer, controlling the vehicle's high level functions. Examples of high level functions are: tracking progress of the RIOT blimp (110) through the mission, handling scenarios and scheduling mission activities such as navigation, inspection, docking and ending the mission. According to some embodiments of the disclosure, the Avionics and Buoyancy subsystem (112) further comprises a magnetic quasi-static fields (MQS) global positioning system (not shown in FIG. 1C), the MQS providing positioning information from a transmitter external to the tank through magnetic field transmissions.

Referring back to FIG. 1A, the Mission planning and control system (120) provides software infrastructure for supporting indoor vision-based navigation, control of various subsystems and mission planning and execution. Before starting a mission, the Mission planning and control system (120) will provide a baseline pre-mission plan to be used by the RIOT blimp (110) during the mission. By way of example and not of limitation, the baseline mission plan may provide a preliminary trajectory of the RIOT blimp (110) within the tank. Moreover, the baseline pre-mission plan may be used to coordinate the RIOT blimp's (110) functions and behaviors throughout the mission. Based on the progress through the mission and the state of the RIOT blimp (110), the mission plan may direct the RIOT blimp (110) to perform different functions such as inspection image acquisition, progress to next inspection region, return to dock etc. According to some embodiments of the disclosure, the Mission planning and control system may use drawings and/or tank models to generate automated pre-mission plans. Such automated pre-mission plans are used to optimize resource usage, mission and inspection criteria (e.g. inspection duration, area of coverage, resolvable defect scale, etc.) The person skilled in the art will appreciate that, in contrast with offline planning performed by the Mission planning and control system (120), during the mission, and referring to FIG. 1B, live control commands of various subsystems are provided by a combination of onboard software run by the IS computers (112C) and the Avionics and buoyancy communication and control boards (112B). Referring to FIGS. 1D-1E, and as an example, the live control commands may serve to control functionalities of the IS cameras (114C), to control thrust of the propellers (113D), to update mission routes based on onboard sensing etc. The person skilled in the art will appreciate that the teachings of the disclosure make an automated, unmanned inspection of large tanks possible through a combination of the pre-mission planning as provided by the Mission Planning and control subsystem (120) with live control of the RIOT blimp (110) navigation and inspection during the missions performed by the Avionics and Buoyancy subsystem (112). In other words, during a mission, the Riot blimp (110) follow pre-programmed survey routes and autonomously updates routes based off of detected obstacles.

According to some embodiments of the disclosure, communication between various subsystems of the RIOT blimp (110) may be through IS wired links, wireless connections or a combination thereof. Further embodiments may be envisaged wherein the IS communication and control boards of various subsystems comprise wireless modems. Referring back to the RIOT blimp (110) of FIG. 1A, the person skilled in the art will appreciate that each of the subsystems (111-115) are designed to be intrinsically safe on an individual basis. Moreover, a design of the RIOT blimp (110) is based on full electrical isolation of the subsystems (111-115) from one another, so that the RIOT blimp (110) as a whole is intrinsically safe and can be used for inspection of hazardous environments such as tanks. The person skilled in the art will understand that although the teachings of the disclosure were mostly presented through embodiments made for inspection of large tanks, without departing from the scope and spirit of the invention, other embodiments may be made for navigation and inspection of environments other than large tanks. In accordance with teachings of the disclosure, embodiments may be made capable of inspecting large tanks wherein the atmosphere mixture can reach 2 kg/m̂3 and/or temperature ranges from 28° to 34° C. with temperatures varying vertically in the tank.

What is claimed is:

1. An intrinsically safe (IS) robotic inspection system for unmanned inspection of environments with hazardous and explosive atmosphere comprising:
1) an IS blimp comprising:
an IS envelope subsystem;
an IS avionics and buoyancy subsystem attached to the IS envelope subsystem;
an IS mobility system attached to the IS envelope subsystem;
an IS inspection subsystem attached to the IS envelope subsystem,
an IS docking subsystem attached to the IS envelope subsystem; and
a ground station subsystem; and
2) a mission planning and control system;
wherein:
(a) the IS blimp is a lighter-than-air blimp;
(b) the IS envelope provides structural support for the IS avionics and buoyancy, the IS mobility, the IS inspection and the IS docking subsystems;
(c) in an operative condition wherein the IS blimp performs navigation and inspection functions within the environments:
(c1) the IS avionics and buoyancy subsystem adjusts an IS blimp buoyancy to compensate for ambient density and temperature gradients;
(c2) the IS avionics and buoyancy subsystem controls the navigation and the inspection functions of the IS blimp by providing control commands to the IS mobility and the IS inspection subsystems;
(c3) the IS mobility subsystem provides propulsion to maneuver the IS blimp; and
(c4) the IS inspection subsystem acquires images of the environments as part of the navigation and inspection functions; and
(d) a combination of the ground station subsystem and the IS docking subsystem provide mechanism for unmanned release and docking of the IS blimp within the environments.
(e) the mission planning and control system provides offline software infrastructure for supporting the navigation and the inspection functions.

2. The robotic inspection system of claim 1, wherein the IS envelope, the IS avionics and buoyancy, the IS mobility, the IS inspection and the IS docking subsystems are electrically isolated from one another.

3. The robotic inspection system of claim 2, wherein the IS avionics and buoyancy, the IS mobility, the IS inspection and the IS docking subsystems communicate with one another through wireless links or IS wired links or a combination thereof.

4. The robotic inspection system of claim 1, wherein the environments comprise a tank.

5. The robotic inspection system of claim 4, wherein the tank is one of a i) cargo, ii) ballast or iii) void tank.

6. The robotic inspection system of claim 1, wherein the IS envelope comprises a ballonet, an inner helium envelope and an outer layer wherein the ballonet is filled with ambient air and the inner helium envelope is filled with helium, the helium serving as lifting gas.

7. The robotic inspection system of claim 1, wherein the IS avionics and buoyancy subsystem comprises avionics and buoyancy IS batteries, avionics and buoyancy IS communication and control boards, IS computers, IS valves, IS pumps, a ballast tank and IS sensors wherein:
the avionics and buoyancy IS communication and control boards, the IS computers, the IS valves, the IS pumps and the IS sensors are powered by the avionics and buoyancy IS batteries;
a combination of the computers and the avionics and buoyancy communication control boards provides control commands for the navigation and inspection functions;
a combination of the IS valves, the IS pumps and the ballast tank is used to adjust the IS blimp buoyancy; and
measurements of the IS sensors are used to navigate the IS blimp within the environments.

8. The robotic inspection system of claim 7, wherein the IS batteries comprise lithium batteries.

9. The robotic inspection system of claim 7, wherein the IS avionics and buoyancy control and command boards comprise wireless modems.

10. The robotic inspection system of claim 7, wherein the IS sensors comprise inertial measurements units.

11. The robotic inspection system of claim 7, wherein the IS avionics and buoyancy control subsystem further comprises a magnetic quasi-static fields (MQS) global positioning system, the MQS providing positioning information from a transmitter external to the environments through magnetic field transmissions

12. The robotic inspection system of claim 7, wherein in the IS mobility subsystem comprises mobility IS batteries, mobility IS communication and control boards, IS motors, IS propellers and an azimuth mechanism block wherein:
the mobility IS communication and control boards, the IS motors, the IS propellers and the azimuth mechanism block are powered by the IS batteries;
the mobility IS communication and control boards receives control commands from the avionics and buoyancy communication control boards, thereby controlling the IS motors and the propellers;
the propulsion to maneuver the IS blimp is provided by a combination of the IS motors and the IS propellers; and
the azimuth mechanism block is driven by a motor of the IS motors thereby allowing thrusts of the IS blimp to be vectored.

13. The robotic inspection system of claim 12, wherein the mobility IS batteries are lithium batteries.

14. The robotic inspection system of claim 12, wherein the mobility IS communication and control boards comprise wireless modems.

15. The robotic inspection system of claim 12, wherein the IS inspection system comprises inspection IS batteries, inspection IS communication and control boards, IS cameras, IS LED lights, an IS reflector and IS inertial sensors wherein:
the inspection IS communication and control boards, the IS cameras, the IS LED lights, the IS reflector and the IS inertial sensors are powered by the inspection IS batteries;
the inspection IS communication and control boards receive control commands from the avionics and buoyancy IS communication and control boards to control the IS cameras, the IS LED lights, the IS reflector and the IS inertial sensors; and
a combination of the IS cameras, the IS LED lights, the IS reflector and the IS inertial sensors is used to capture images of the environments as part of the navigation and inspection functions.

16. The robotic inspection system of claim 15, wherein the inspection IS batteries comprise lithium batteries.

17. The robotic inspection system of claim 15, wherein the inspection IS communication and control boards comprise wireless modems.

18. The robotic inspection system of claim 15, wherein the IS cameras comprise a high resolution miniature camera and lens selected to provide adequate viewshed and resolution of sub-centimeter scale features.

19. The robotic inspection system of claim 15, wherein the IS cameras comprise one of a) infrared cameras, b) visible light cameras, c) non-contact 3D reconstruction sensor such as a Lidar or a combination thereof.

20. The robotic inspection system of claim 15, wherein cm-scale image localization accuracy and/or mm-scale feature size detectability is achieved using a combination of the IS cameras and the IS inertial sensors.

21. The robotic inspection system of claim 15, wherein the IS docking subsystem comprises docking IS batteries, docking IS communication and control boards, an IS latching motor and a proximity switch wherein:
the docking IS communication and control boards, the IS latching motor and the proximity switch are powered by the IS batteries;
the docking IS communication boards provide control commands to the IS latching motor and the proximity switch; and
the mechanism for unmanned release and docking of the IS blimp within the environments is provided by a combination of the IS latching motor and the proximity switch.

22. The robotic inspection system of claim 21, wherein the IS batteries are lithium batteries.

23. The robotic inspection system of claim 22, wherein the IS communication and control boards comprise wireless modems.

24. The robotic inspection of claim 1, wherein the offline software infrastructure provides an automated baseline pre-mission plan, the automated baseline pre-mission plan:
providing a preliminary trajectory for the IS blimp within the environments;
being used to coordinate the navigation and the inspection functions; and
providing commands to the IS blimp to perform one or more of i) inspection image acquisition, ii) progress from one inspection region to a following inspection region, and iii) return to a docking station.

25. The robotic inspection system of claim 24, wherein the offline software infrastructure uses drawing and/or models of the environments to generate the automated baseline pre-mission plan.

26. the robotic inspection system of claim 25, wherein the pre-mission plan is used to optimize resource usage, mission and inspection criteria wherein the mission and inspection criteria are one or more of i) inspection duration, ii) area of coverage within the environments, and iii) resolvable defect scale.

27. An automated and unmanned method of navigating and inspecting a tank with hazardous and explosive atmosphere, the method comprising the steps of:
providing an intrinsically safe (IS) and lighter-than-air blimp,
attaching IS cameras, IS LED light, IS sensors, IS motors, IS propellers, IS computers and IS communication and control boards to the blimp to provide a robotic inspection system, the robotic inspection system being intrinsically safe;
docking the robotic inspection system on a docking station within the tank;
releasing the robotic inspection system to start a mission;
providing control commands to the IS cameras, the IS LED lights, the IS sensors, the IS propellers using a combination of the IS computers and the IS communication and control boards;
adjusting the blimp's buoyancy during the mission;
providing a vectored propulsion to maneuver the blimp during the mission and using a combination of the IS sensors, the IS motors and the IS propellers;
acquiring images of the tank environment using a combination of the IS cameras and the IS LED lights; and
returning to the docking station at an end of the mission.

28. The robotic inspection system of claim 7, wherein the IS computers incorporate encapsulation in accordance with an IS standard chosen from one of a) International Electrical Commission (IEC) IEC 60079-11, b) Factory Mutual (FM) 3610, or c) Underwriters Laboratories (UL) UL913.

29. The robotic inspection system of claim 1, wherein the ground station subsystem comprises:
an IS docking mechanism;
an IS hoist mechanism;
helium gas lines;
an IS communication antenna; and
an IS feed through harnessing;
wherein during a deployment:
the IS hoist mechanism is configured to lower the IS blimp into a tank;
the helium gas lines are used to fill the IS blimp when is the IS blimp is lowered;
the IS docking mechanism release the IS blimp once the IS blimp is filled with helium;
the IS communication antenna provides a communication link between the IS blimp and communication and computing infrastructures exterior to the tank; and
the IS feedthrough harnessing provides power and communication channels through a tank hatch or an air lock to the ground station subsystem.

30. The robotic inspection system of claim 29, wherein the hoist mechanism comprises an winch or a boom.
